(19) United States
(12) Patent Application Publication
(10) Pub. No.: US 2005/0128771 A1
(43) Pub. Date: Jun. 16, 2005

(54) Backlight unit for a liquid crystal display device

(75) Inventor: Mitsuru Tanaka, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 10/993,154

(22) Filed: Nov. 22, 2004

(30) Foreign Application Priority Data
Nov. 20, 2003 (JP) 2003-390191

(51) Int. Cl. G02F 1/1333

(52) U.S. Cl. 362/613

(57) ABSTRACT

Four straight tube type Cold Cathode Fluorescent Lamps are placed such that the distance from the two inner Cold Cathode Fluorescent Lamps to a reflection surface of a reflector plate is shorter than the distance from the two outer Cold Cathode Fluorescent Lamps to the reflection surface of the reflector plate, whereby it becomes possible to make the distance from the two inner Cold Cathode Fluorescent Lamps to a liquid crystal panel longer than the distance from the two outer Cold Cathode Fluorescent Lamps to the liquid crystal panel. Generally, unevenness in brightness on the display screen is caused by higher brightness in the vicinity of each of the Cold Cathode Fluorescent Lamps. Accordingly, by making longer the distance from the two inner Cold Cathode Fluorescent Lamps to the liquid crystal panel, it becomes possible to prevent unevenness in brightness at a central portion of the display screen, which is more likely to be noticed by users, thereby improving the image quality of the liquid crystal display device.

### BACKGROUND OF THE INVENTION

1. Field of the Invention

The present invention relates to a backlight unit, and more particularly to a backlight unit of direct type to illuminate a liquid crystal panel of a liquid crystal display device from behind.

2. Description of the Related Art

Liquid crystal display devices, which have advantages e.g. in space and energy savings, are becoming common in the prior art, replacing CRT (cathode ray tube) display devices. As shown in FIG. 4, a conventional liquid crystal display device 100 comprises a liquid crystal panel 101 to act as an electronic shutter and a backlight unit 102 to serve as a light source. The liquid display panel 101 controls the light transmission of light illuminated by the backlight unit 102 so as to display images. Note that in FIG. 4 and later described FIGS. 5 and 6 according to the prior art as well as FIGS. 1 through 3 according to the present invention, the height and width directions of a backlight unit and a display screen of a liquid crystal panel are designated by H and W, respectively.

In backlight units, there are those of direct type, such as the backlight unit 102, and those of side edge type. In the case of the backlight units of direct type such as the backlight unit 102, it is possible to arbitrarily increase the number of lamps, so that they are used for liquid crystal display devices that require high screen brightness. As shown in FIG. 5, the direct type backlight unit 102 comprises: plural Cold Cathode Fluorescent Lamps 103 to illuminate the liquid crystal panel 101 from behind; a reflector plate 104 formed of a metal frame 141 covered with a reflection sheet 142 having a reflection surface to reflect light from the Cold Cathode Fluorescent Lamps 103; a diffuser plate 105 to diffuse the direct light from the Cold Cathode Fluorescent Lamps and the reflected light from the reflector plate 104 so as to illuminate forward; a laminated sheet 106 formed of a combination of plural sheets such as a lens sheet, a diffusion sheet and the like; a mold frame 107 to fix these elements; and so on.

In such direct type backlight unit 102, in some cases, unevenness in brightness may occur on the display panel of the liquid crystal panel 101 depending on e.g. the way of arranging the Cold Cathode Fluorescent Lamps 103, so that there is a possibility that the image quality decreases. Thus, in order to improve the image quality of the liquid crystal display device 100, it becomes an important problem to increase the evenness in brightness of the emission surface of the direct type backlight unit 102.

For solving this problem, there are proposed some techniques as follows. Japanese Laid-open Patent Publication 2001-22285 discloses a direct type backlight unit in which the relationship among three basic elements, that are the distance between lamps placed in parallel, the distance between the center axis of the lamp and the diffuser plate, and the light transmission rate of the diffuser plate, is set within a certain range. It is only by such basic elements of direct type backlight unit that this technique attempts to increase the brightness, reduce the thickness and increase the evenness in brightness of the backlight unit.

Japanese Laid-open Patent Publication 2002-82626 discloses a direct type backlight unit in which the distances between adjacent straight tube type lamps are set so as to be shorter at a central portion of a display screen of a liquid crystal panel, and to become longer toward ends of the display screen. This technique attempts to reduce power consumption of the direct type backlight unit while securing practical brightness of the display screen, without changing the components that constitute the backlight unit.

However, in each of the backlight units as disclosed in both references above, each lamp is placed at a constant distance from the reflection surface of a reflector plate. Accordingly, in order to prevent unevenness in brightness or shadow of light on the display screen, there is no other way than to increase the number of lamps or use a good laminated sheet. This causes the number of components to increase, which is disadvantageous in terms of cost.

An advantage of placing each lamp at a constant distance from the reflection surface of a reflector plate, as in the above conventional backlight units, is that the main body of the liquid crystal display device can be reduced in thickness. More specifically, in the case where the Cold Cathode Fluorescent Lamps (lamps) 103 are placed in parallel with each other such that distance D′2 between each Cold Cathode Fluorescent Lamp 103 and the reflection surface of each reflector plate 104 is constantly the same as shown in FIG. 6, it is easy to reduce the thickness of main body 110 of the liquid crystal display device.

However, a stand 120 is often used to place the liquid crystal display device 100 having the backlight unit 102 as shown in FIG. 4. In the case of placing the liquid crystal display device 100 in an installation space using the stand 120, the installation space is required to have a width equal to or greater than width D′ of the foot of the stand 120. Accordingly, even if thickness D′1 of the main body 110 of the liquid crystal display device 100 increases a little or to some extent, it is considered that such increased thickness does not cause a significant problem with respect to the installation space. Rather, even if the thickness D′1 of the main body 110 of the liquid crystal display device 100 may increase a little, it is considered that a better liquid crystal display device can be obtained based on the increased thickness. More specifically, if the liquid crystal display device 100 with the increased thickness D′1 can be improved in image quality and reduced in cost, the superiority of the liquid crystal display device 100 to the CRT display device is considered to further increase, since the liquid crystal display device 100 is thin enough as compared to the CRT display device.

### SUMMARY OF THE INVENTION

An object of the present invention is to provide such a backlight unit for a liquid crystal display device that can prevent unevenness of brightness on a display screen of the liquid crystal display device so as to improve the image quality of the liquid crystal display device, and makes it possible to reduce the number of components required therefor so as to reduce the cost.

According to a first aspect of the present invention, the above object is achieved by a backlight unit for a liquid crystal display device which is of direct type and includes a liquid crystal panel having a display screen with width and height, comprising: plural straight tube type lamps to illuminate the liquid crystal panel from behind; and a reflector plate placed behind the straight tube type lamps and having a reflection surface to reflect light from the straight tube type lamps, wherein each of the straight tube type lamps is placed substantially in parallel to width direction of the display screen, and wherein distance from ones of the straight tube type lamps, which are placed at a central portion in height direction of the display screen, to the reflection surface of the reflector plate is shorter than distance from the other ones of the straight tube type lamps, which are placed at upper and lower edge portions in height direction of the display screen, to the reflection surface of the reflector plate.

By making the distance from ones of the straight tube type lamps, which are placed at the central portion in height direction of the display screen, to the reflection surface of the reflector plate shorter than the distance from the other ones of the straight tube type lamps, which are placed at upper and lower edge portions in height direction of the display screen, to the reflection surface of the reflector plate as in the above configuration, it becomes possible to make the distance from ones of the straight tube type lamps, which are placed at the central portion in height direction of the display screen, to the liquid crystal panel longer than the distance from the other ones of the straight tube type lamps, which are placed at upper and lower edge portions in height direction of the display screen, to the liquid crystal panel. Generally, unevenness in brightness on the display screen is caused by higher brightness in the vicinity of each of the lamps. Accordingly, by making longer the distance from ones of the straight tube type lamps, which are placed at the central portion in height direction of the display screen, to the liquid crystal panel, it becomes possible to prevent unevenness in brightness at a central portion of the display screen, which is more likely to be noticed by users, thereby improving the image quality of the liquid crystal display device.

Preferably, distance between adjacent ones of the straight tube type lamps at a central portion in height direction of the display screen is shorter than distance between adjacent ones of the straight tube type lamps at upper and lower edge portions of the display screen.

Further, it is possible that at least four of the straight tube type lamps are composed of at least two U-shaped Cold Cathode Fluorescent Lamps.

According to a second aspect of the present invention, the above object is achieved by a backlight unit for a liquid crystal display device which is of direct type and includes a liquid crystal panel having a display screen with width and height, comprising: four straight tube type Cold Cathode Fluorescent Lamps to illuminate the liquid crystal panel from behind; and a reflector plate placed behind the straight tube type Cold Cathode Fluorescent Lamps and having a reflection surface to reflect light from the straight tube type Cold Cathode Fluorescent Lamps, wherein each of the straight tube type Cold Cathode Fluorescent Lamps is placed substantially in parallel to width direction of the display screen in a manner that the straight tube type Cold Cathode Fluorescent Lamps are placed symmetrically up and down in height direction of the display screen with respect to a cross-sectional plane, as a plane of symmetry, which passes through substantially the center in height direction of the display screen of the liquid crystal panel, and wherein distance from two inner ones of the straight tube type Cold Cathode Fluorescent Lamps to the reflection surface of the reflector plate is shorter than distance from two outer ones of the straight tube type Cold Cathode Fluorescent Lamps to the reflection surface of the reflector plate.

By making the distance from two inner ones of the four straight tube type Cold Cathode Fluorescent Lamps to the reflection surface of the reflector plate shorter than the distance from two outer ones of the four straight tube type Cold Cathode Fluorescent Lamps to the reflection surface of the reflector plate as in the above configuration, it becomes possible to make the distance from the two inner ones of the four straight tube type Cold Cathode Fluorescent Lamps to the liquid crystal panel longer than the distance from the two outer ones of the four straight tube type Cold Cathode Fluorescent Lamps to the liquid crystal panel. Generally, unevenness in brightness on the display screen is caused by higher brightness in the vicinity of each of the Cold Cathode Fluorescent Lamps. Accordingly, by making longer the distance from the two inner ones of the four straight tube type Cold Cathode Fluorescent Lamps to the liquid crystal panel, it becomes possible to prevent unevenness in brightness at a central portion of the display screen, which is more likely to be noticed by users, thereby improving the image quality of the liquid crystal display device.

Preferably, distance between the two inner straight tube type Cold Cathode Fluorescent Lamps is shorter than distance from each of the two inner straight tube type Cold Cathode Fluorescent Lamps to one of the two outer straight tube type Cold Cathode Fluorescent Lamps which is adjacent to the each of the two inner straight tube type Cold Cathode Fluorescent Lamps.

Further, it is possible that the two upper ones of the four straight tube type Cold Cathode Fluorescent Lamps are composed of a U-shaped Cold Cathode Fluorescent Lamp, while the two lower ones of the four straight tube type Cold Cathode Fluorescent Lamps are composed of a further U-shaped Cold Cathode Fluorescent Lamp.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic exploded perspective view of a backlight unit according to a first embodiment of the present invention;

FIG. 2 is a schematic cross-sectional view of the backlight unit along A-A line of FIG. 1 as mounted on a liquid crystal panel;

FIG. 3 is a schematic exploded perspective view of a backlight unit according to a second embodiment of the present invention;

FIG. 4 is a schematic side view of a liquid crystal display device according to prior art;

FIG. 5 is a schematic exploded perspective view of a backlight unit according to the prior art; and

FIG. 6 is a schematic cross-sectional view of the backlight unit according to the prior art along A′-A′ line of FIG. 5 as mounted on a liquid crystal panel.

### DESCRIPTION OF THE PREFERRED EMBODIMENTS

The best modes and preferred embodiments of the present invention will be described hereinafter with reference to the annexed drawings. The specific embodiments described are not intended to cover the entire scope of the present invention of the present invention, and hence the present invention is not limited to only the specific embodiments.

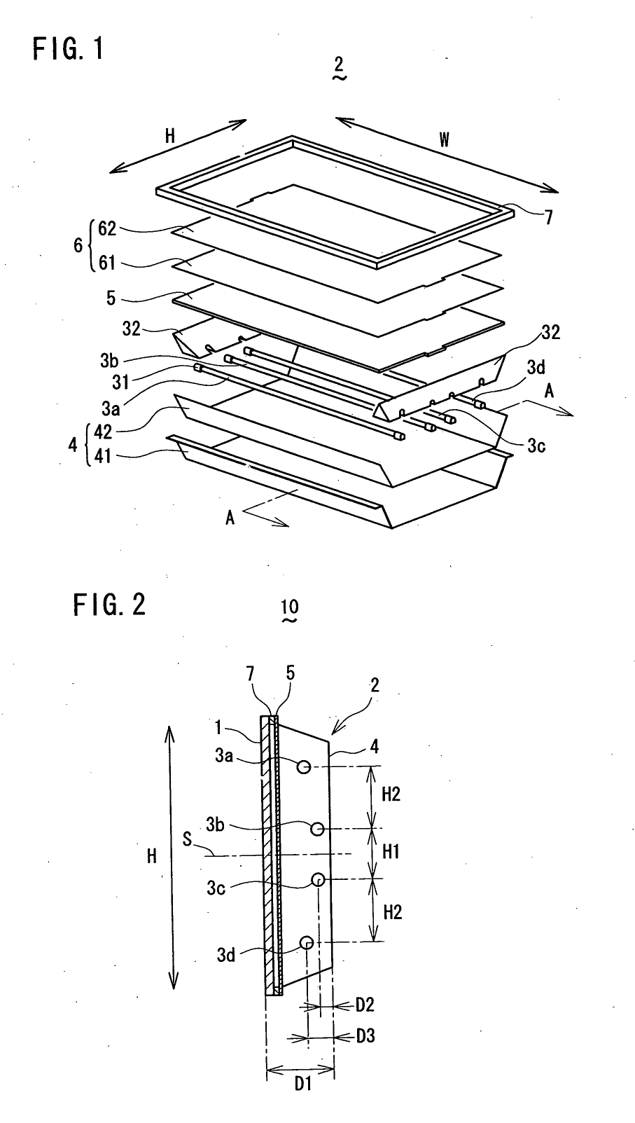

FIG. 1 and FIG. 2 show a backlight unit 2 according to a first embodiment of the present invention. The backlight unit 2 comprises: four straight tube type Cold Cathode Fluorescent Lamps (straight tube type lamps) 3a to 3d to illuminate a liquid crystal panel 1 from behind; a reflector plate 4 placed behind the Cold Cathode Fluorescent Lamps 3a to 3d and having a reflection surface to reflect light from the straight tube type Cold Cathode Fluorescent Lamps 3a to 3d; a diffuser plate 5 to diffuse the direct light from the straight tube type Cold Cathode Fluorescent Lamps 3a to 3d and the reflected light from the reflector plate 4 so as to illuminate forward; a laminated sheet 6 formed of plural functional sheets; a mold frame 7 to fix these elements; and so on.

Each of the straight tube type Cold Cathode Fluorescent Lamps 3a to 3d has lamp sockets 31 fixed to both ends thereof, and is connected to an inverter circuit (not shown) via the lamp sockets 31. Furthermore, the straight tube type Cold Cathode Fluorescent Lamps 3a to 3d are fixed in front of the reflector plate 4 by lamp holders 32 in a manner that the lamp holders 32 cover the vicinity of both ends of each of the straight tube type Cold Cathode Fluorescent Lamps 3a to 3d. The reflector plate 4 is formed of a metal frame 41 covered with a reflection sheet 42 having a reflection surface with a high reflectivity to reflect light from the Cold Cathode Fluorescent Lamps 3a to 3d, and has slope portions at both ends or edges in the height direction H to collect light to the liquid crystal panel 1. The laminated sheet 6 is formed of a combination of plural sheets such as a lens sheet 61 and a diffusion sheet 62 to brighten the display screen.

Next, the placement of the above four straight tube type Cold Cathode Fluorescent Lamps 3a to 3d will be described in more detail. These four straight tube type Cold Cathode Fluorescent Lamps 3a to 3d are placed such that distance D2 from the two inner straight tube type Cold Cathode Fluorescent Lamps 3b and 3c, which are placed at a central portion in the height direction of the display screen, to the reflection surface of the reflector plate 4 is shorter than distance D3 from the two outer straight tube type Cold Cathode Fluorescent Lamps 3a and 3d to the reflection surface of the reflector plate 4. By placing the straight tube type Cold Cathode Fluorescent Lamps 3a to 3d so as to make the distance D2 shorter than the distance D3, it becomes possible to make the distance from the two inner straight tube type Cold Cathode Fluorescent Lamps 3b and 3c to the liquid crystal panel 1 longer than the distance from the two outer straight tube type Cold Cathode Fluorescent Lamps 3a and 3d to the liquid crystal panel 1.

The unevenness in brightness on the display screen is caused by higher brightness on the display screen in the vicinity of each of the straight tube type Cold Cathode Fluorescent Lamps 3a to 3d. Accordingly, by making longer the distance from the two inner straight tube type Cold Cathode Fluorescent Lamps 3b and 3c to the liquid crystal panel 1, it becomes possible to prevent unevenness in brightness at a central portion of the display screen, which is more likely to be noticed by users, thereby improving the image quality of the liquid crystal display device. In the present embodiment, the brightness at a central portion of the display screen is designed to be higher than the brightness at the upper and lower edge portions of the display screen as will be described later. Accordingly, by making longer the distance from the two inner straight tube type Cold Cathode Fluorescent Lamps 3b and 3c to the liquid crystal panel 1, it becomes possible to more effectively prevent the unevenness in brightness at the central portion of the display screen.

According to the conventional backlight unit 102, as shown in FIG. 6, the distance D′2 from the Cold Cathode Fluorescent Lamps 103 to the reflection surface of the reflector plate 104 is designed to be constantly the same, in which an attempt to prevent the unevenness in brightness on the display screen is made by increasing the number of the Cold Cathode Fluorescent Lamps 103 or using the better laminated sheet 106. In contrast, in the backlight unit 2 according to the present embodiment, the unevenness in brightness on the display screen is prevented by varying the distances D2 and D3 from the straight tube type Cold Cathode Fluorescent Lamps 3a to 3d to the reflection surface of the reflector plate 4 for each of the straight tube type Cold Cathode Fluorescent Lamps 3a to 3d. Although this causes the thickness D1 of the main body 10 of the liquid crystal display device in the case of the backlight unit 2 according to the present embodiment to be greater than the thickness D′1 of the main body 110 of the conventional liquid crystal display device, it becomes possible to reduce the cost of the backlight unit by reducing the number of Cold Cathode Fluorescent Lamps together with the number of corresponding components such as lamp sockets 31 and inverter circuits as well as the cost of the laminated sheet as compared with the case of the conventional backlight unit 102.

In the present embodiment, furthermore, the straight tube type Cold Cathode Fluorescent Lamps 3a to 3d are placed such that distance H1 in the height direction H of the display screen between the two inner straight tube type Cold Cathode Fluorescent Lamps 3b and 3c is shorter than distance H2 in the height direction H of the display screen, either between the inner straight tube type Cold Cathode Fluorescent Lamp 3b and the adjacent outer straight tube type Cold Cathode Fluorescent Lamp 3a, or between the inner straight tube type Cold Cathode Fluorescent Lamp 3c and the adjacent outer straight tube type Cold Cathode Fluorescent Lamp 3d. According to the backlight unit 2 of the present embodiment, the brightness at a central portion of the display screen can be made higher than the brightness at the upper and lower edge portions of the display screen by making the distance H1 shorter than the distance H2 in placing the straight tube type Cold Cathode Fluorescent Lamps 3a to 3d. So, it becomes possible to effectively use light illuminated from the straight tube type Cold Cathode Fluorescent Lamps 3a to 3d, and reduce the number of Cold Cathode Fluorescent Lamps as well as the number of the corresponding components as compared with the case of the conventional backlight unit 102, while securing practical brightness of the display screen, whereby the cost of the backlight unit can be reduced.

Besides, the straight tube type Cold Cathode Fluorescent Lamps 3a to 3d are placed substantially in parallel to the width direction W of the display screen in a manner that they are placed symmetrically up and down with respect to a cross-sectional plane S (see FIG. 2), as a plane of symmetry, which passes through substantially the center of the display screen of the liquid crystal panel 1. By placing the straight tube type Cold Cathode Fluorescent Lamps 3a to 3d substantially in parallel to the width direction W of the display screen, it becomes possible to make the length of each of the straight tube type Cold Cathode Fluorescent Lamps 3a to 3d longer than that in the case where the straight tube type Cold Cathode Fluorescent Lamps 3a to 3d are placed substantially in parallel to the height direction H of the display screen. Thereby, it becomes possible to reduce the number of Cold Cathode Fluorescent Lamps as well as the number of the corresponding components, while securing sufficient brightness of the display screen, as compared with the case where the straight tube type Cold Cathode Fluorescent Lamps 3a to 3d are placed substantially in parallel to the height direction H of the display screen.

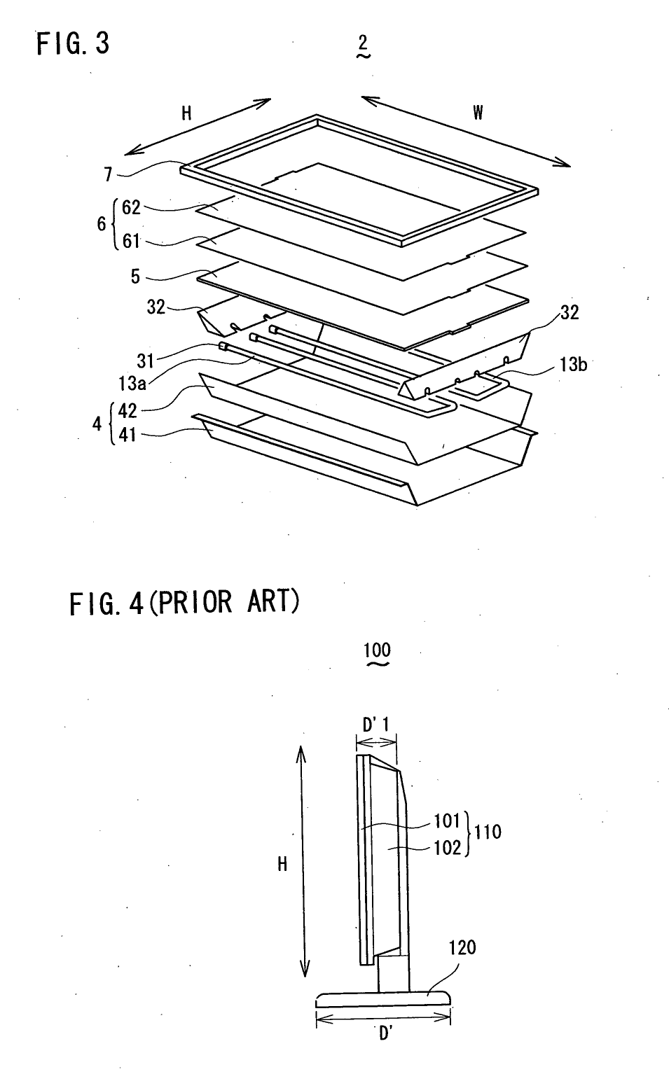

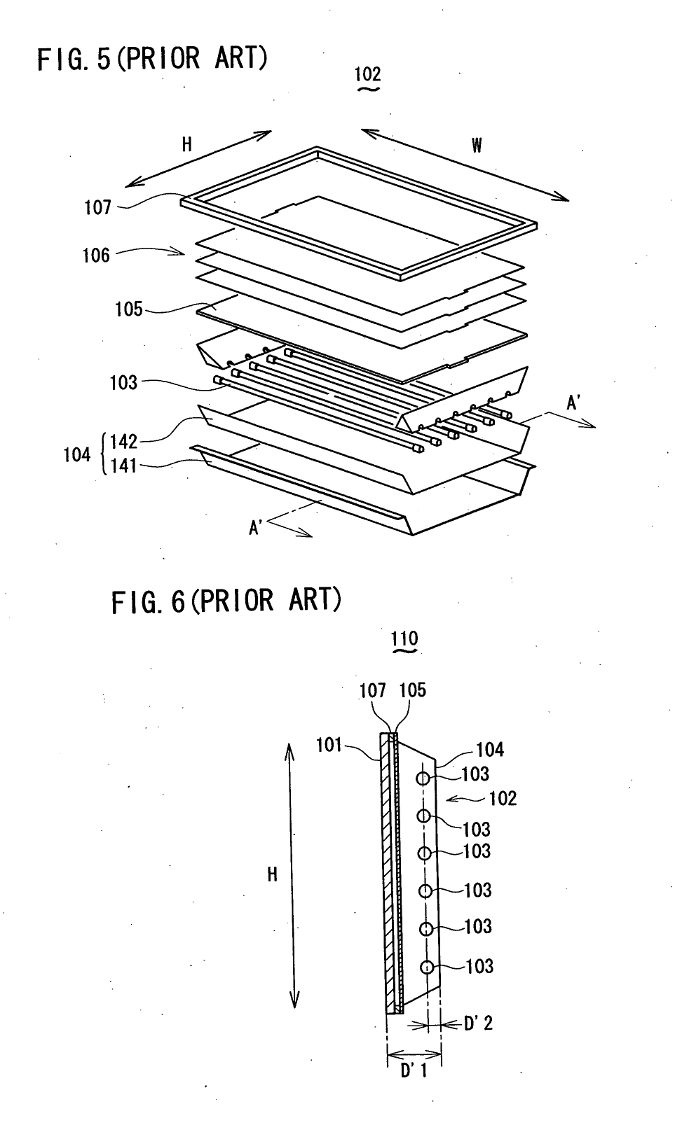

Next, referring to FIG. 3, a backlight unit according to a second embodiment of the present invention will be described. The backlight unit 2 of the second embodiment is different from the backlight unit 2 of the first embodiment in that the second embodiment uses U-shaped Cold Cathode Fluorescent Lamps 13a and 13b. As shown in FIG. 3, according to the backlight unit 2 of the second embodiment, the two upper straight tube type Cold Cathode Fluorescent Lamps 3a and 3b of the first embodiment are replaced by or composed of a U-shaped Cold Cathode Fluorescent Lamp 13a, while the two lower straight tube type Cold Cathode Fluorescent Lamps 3c and 3d of the first embodiment are replaced by or composed of a further U-shaped Cold Cathode Fluorescent Lamp 13b. By substituting the two U-shaped Cold Cathode Fluorescent Lamps 13a and 13b for the four straight tube type Cold Cathode Fluorescent Lamps 3a to 3d, it becomes possible to reduce the number of components such as inverter circuits and lamp sockets 31, thereby reducing the cost of the backlight unit.

It is to be noted that the present invention is not limited to the structures or configurations of the above embodiments, and various modifications are possible. For example, it is not required to limit the kind of Cold Cathode Fluorescent Lamps used for the lamps to only one type, either the straight tube type Cold Cathode Fluorescent Lamps or the U-shaped Cold Cathode Fluorescent Lamps. It is possible to use both types of Cold Cathode Fluorescent Lamps in combination. Further, although the above embodiments have described the case where the Cold Cathode Fluorescent Lamps are placed substantially in parallel to the width direction of the display screen, it is possible to place the Cold Cathode Fluorescent Lamps substantially in parallel to the height direction of the display screen. Furthermore, the number of the Cold Cathode Fluorescent Lamps to be used is not required to be an even number. It can be an odd number. In the case of an odd number, it is possible to place Cold Cathode Fluorescent Lamps symmetrically up and down or symmetrically left and right with respect to a plane of symmetry perpendicular to the display screen by placing one Cold Cathode Fluorescent Lamp in the vicinity of the plane of symmetry. In addition, although Cold Cathode Fluorescent Lamps are used for the lamps in the above embodiments, other kinds of lamps can be used instead.

This application is based on Japanese patent application 2003-390191 filed Nov. 20, 2003, the contents of which are hereby incorporated by reference.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

1. A backlight unit for a liquid crystal display device which is of direct type and includes a liquid crystal panel having a display screen with width and height, comprising:
plural straight tube type lamps to illuminate the liquid crystal panel from behind; and
a reflector plate placed behind the straight tube type lamps and having a reflection surface to reflect light from the straight tube type lamps,
wherein each of the straight tube type lamps is placed substantially in parallel to width direction of the display screen, and
wherein distance from ones of the straight tube type lamps, which are placed at a central portion in height direction of the display screen, to the reflection surface of the reflector plate is shorter than distance from the other ones of the straight tube type lamps, which are placed at upper and lower edge portions in height direction of the display screen, to the reflection surface of the reflector plate.

2. The backlight unit for a liquid crystal display device according to claim 1, wherein distance between adjacent ones of the straight tube type lamps at a central portion in height direction of the display screen is shorter than distance between adjacent ones of the straight tube type lamps at upper and lower edge portions of the display screen.

3. The backlight unit for a liquid crystal display device according to claim 2, wherein at least four of the straight tube type lamps are composed of at least two U-shaped Cold Cathode Fluorescent Lamps.

4. The backlight unit for a liquid crystal display device according to claim 1, wherein at least four of the straight tube type lamps are composed of at least two U-shaped Cold Cathode Fluorescent Lamps.

5. A backlight unit for a liquid crystal display device which is of direct type and includes a liquid crystal panel having a display screen with width and height, comprising:
four straight tube type Cold Cathode Fluorescent Lamps to illuminate the liquid crystal panel from behind; and
a reflector plate placed behind the straight tube type Cold Cathode Fluorescent Lamps and having a reflection surface to reflect light from the straight tube type Cold Cathode Fluorescent Lamps,
wherein each of the straight tube type Cold Cathode Fluorescent Lamps is placed substantially in parallel to width direction of the display screen in a manner that the straight tube type Cold Cathode Fluorescent Lamps are placed symmetrically up and down in height direction of the display screen with respect to a cross-sectional plane, as a plane of symmetry, which passes through substantially the center in height direction of the display screen of the liquid crystal panel, and
wherein distance from two inner ones of the straight tube type Cold Cathode Fluorescent Lamps to the reflection surface of the reflector plate is shorter than distance from two outer ones of the straight tube type Cold Cathode Fluorescent Lamps to the reflection surface of the reflector plate.

6. The backlight unit for a liquid crystal display device according to claim 5, wherein distance between the two inner straight tube type Cold Cathode Fluorescent Lamps is shorter than distance from each of the two inner straight tube type Cold Cathode Fluorescent Lamps to one of the two outer straight tube type Cold Cathode Fluorescent Lamps which is adjacent to the each of the two inner straight tube type Cold Cathode Fluorescent Lamps.

7. The backlight unit for a liquid crystal display device according to claim 6, wherein the two upper ones of the four straight tube type Cold Cathode Fluorescent Lamps are composed of a U-shaped Cold Cathode Fluorescent Lamp, while the two lower ones of the four straight tube type Cold Cathode Fluorescent Lamps are composed of a further U-shaped Cold Cathode Fluorescent Lamp.

8. The backlight unit for a liquid crystal display device according to claim 5, wherein the two upper ones of the four straight tube type Cold Cathode Fluorescent Lamps are composed of a U-shaped Cold Cathode Fluorescent Lamp, while the two lower ones of the four straight tube type Cold Cathode Fluorescent Lamps are composed of a further U-shaped Cold Cathode Fluorescent Lamp.
